(19) United States
(12) Patent Application Publication
(10) Pub. No.: US 2026/0235900 A1
(43) Pub. Date: Aug. 13, 2026

(54) DISPLAY SUBSTRATE AND DISPLAY APPARATUS

(71) Applicants: Hefei Xinsheng Optoelectronics Technology Co., Ltd., Hefei, Anhui (CN); BOE Technology Group Co., Ltd., Beijing (CN)

(72) Inventors: Ran ZHANG, Beijing (CN); Xinxia ZHANG, Beijing (CN); Feifei ZHU, Beijing (CN); Chengyong ZHAN, Beijing (CN)

(21) Appl. No.: 19/471,016

(22) PCT Filed: Sep. 12, 2023
(86) PCT No.: PCT/CN2023/118376

§ 371 Date: Sep. 30, 2025

(51) Int. Cl. G02F 1/1333; G02F 1/1335; G02F 1/1362

(52) U.S. Cl. CPC G02F 1/133368; G02F 1/133512; G02F 1/133514; G02F 1/136204

(57) ABSTRACT

A display substrate and a display apparatus. The display substrate comprises a display area. The display substrate comprises a first substrate (101), a second substrate (102), and a liquid crystal layer (40). The first substrate (101) and the second substrate (102) are arranged opposite one another. The liquid crystal layer (40) is located between the first substrate (101) and the second substrate (102). The first substrate (101) comprises a first base substrate (10), a driving circuit layer (20) located on a side of the first base substrate (10) facing the second substrate (102), a pixel electrode (32) located on a side of the first base substrate (10) facing the second substrate (102), and a common electrode (31). The second substrate (102) comprises a second base substrate (50) and a transparent conductive layer (60) located on a side of the second base substrate (50) facing the first substrate (101), and the transparent conductive layer (60) is at least located in the display area. The display apparatus comprises the display substrate.

The present disclosure is a U.S. national stage of international application No. PCT/CN 2023/118376, filed on Sep. 12, 2023, the content of which is incorporated herein by reference in its entirety.

### TECHNICAL FIELD

The present disclosure relates to the field of display technologies, and in particular, relates to a display substrate and a display apparatus.

### BACKGROUND

With the continuous development of display technologies, display devices such as mobile phones, laptops, and TVs have become necessities in people's work and life. Liquid crystal display devices have become mainstream display devices due to their advantages such as high brightness, bright colors, and wide viewing angles.

### SUMMARY

The present disclosure provides a display substrate and a display apparatus.

According to some embodiments of the present disclosure, a display substrate is provided. The display substrate is provided with a display region and includes a first substrate, a second substrate disposed opposite to the first substrate, and a liquid crystal layer disposed between the first substrate and the second substrate; wherein

the first substrate includes a first base, and a drive circuit layer, pixel electrodes, and common electrodes that are disposed on a side of the first base facing the second substrate; and the second substrate includes a second base and a transparent conductive layer disposed on a side of the second base facing the first substrate, the transparent conductive layer being at least disposed in the display region.

In some embodiments, an orthographic projection of the transparent conductive layer on the second base covers the second base.

In some embodiments, the transparent conductive layer is provided with multiple hollowed-out portions.

In some embodiments, the second substrate further includes a light-shielding layer disposed on the side of the second base facing the first substrate, the light-shielding layer is provided with multiple openings, and an orthographic projection of each of the hollowed-out portions on the second base at least partially overlaps an orthographic projection of one of the openings on the second base.

In some embodiments, the second substrate further includes patterned functional layers disposed on the side of the second base facing the first substrate, and an orthographic projection of the transparent conductive layer on the second base overlaps an orthographic projection of one of the functional layers on the second base.

In some embodiments, the second substrate further includes a light-shielding layer and a color filter layer that are disposed on the side of the second base facing the first substrate, the light-shielding layer is provided with multiple openings, the color filter layer includes color filter sub-layers of at least three different colors, and the patterned functional layers includes the light-shielding layer and the color filter sub-layers.

In some embodiments, the transparent conductive layer includes multiple strip-shaped conductive structures extending in a same direction, and adjacent strip-shaped conductive structures are arranged at intervals.

In some embodiments, the second substrate further includes a light-shielding layer provided with openings and a color filter layer at least partially located in the openings, both of which are disposed on the side of the second base facing the first substrate; and

the transparent conductive layer is disposed between the second base and the light-shielding layer.

In some embodiments, the second substrate further includes a light-shielding layer provided with openings, a color filter layer at least partially located in the openings, and a planarization layer located on a side of the color filter layer away from the second base, all of which are disposed on the side of the second base facing the first substrate; and

the transparent conductive layer is disposed between the color filter layer and the planarization layer.

In some embodiments, the second substrate further includes a light-shielding layer provided with openings, a color filter layer at least partially located in the openings, and a planarization layer located on a side of the color filter layer away from the second base, all of which are disposed on the side of the second base facing the first substrate; and

the transparent conductive layer is disposed on a side of the planarization layer away from the second base.

In some embodiments, the second substrate further includes an electrostatic discharge layer disposed on a side of the second base away from the first substrate; and

a thickness of the transparent conductive layer is less than or equal to a thickness of the electrostatic discharge layer.

In some embodiments, a minimum thickness of the transparent conductive layer is equal to 10% of the thickness of the electrostatic discharge layer.

In some embodiments, the transparent conductive layer is connected to a constant electrical signal.

In some embodiments, the second substrate further includes an electrostatic discharge layer disposed on a side of the second base away from the first substrate, the electrostatic discharge layer being connected to a constant electrical signal; and

the transparent conductive layer is electrically connected to the electrostatic discharge layer.

In some embodiments, the second substrate further includes a conductive portion disposed on a side portion of the second base, and both the electrostatic discharge layer and the transparent conductive layer are electrically connected to the conductive portion.

In some embodiments, the transparent conductive layer is in contact with the second base, and an orthographic projection of the transparent conductive layer on the second base covers the second base; the second substrate further includes a light-shielding layer disposed on a side of the transparent conductive layer away from the second base, a color filter layer disposed at least partially on a side of the light-shielding layer away from the second base, a planarization layer disposed on a side of the color filter layer away from the second base, and a liquid crystal alignment film disposed on a side of the planarization layer away from the second base.

In some embodiments, the second base, the light-shielding layer, the color filter layer, and the planarization layer each have a thickness greater than a thickness of the transparent conductive layer.

In some embodiments, the first substrate includes multiple pixel electrodes arranged spaced apart, and an orthographic projection of a gap between adjacent pixel electrodes on the second base falls within an orthographic projection of the transparent conductive layer on the second base.

In some embodiments, a material of the transparent conductive layer includes at least one of metal oxides, graphene, metal nanowires, carbon nanotubes, conductive polymers, and poly(3,4-ethylenedioxythiophene)-polystyrene sulfonic acid.

According to embodiments of the present disclosure, a display apparatus is provided. The display apparatus includes the display substrate as described above.

### BRIEF DESCRIPTION OF DRAWINGS

FIG. 1 is a partial cross-sectional view of a display substrate according to some embodiments of the present disclosure;

FIG. 2 is a partial cross-sectional view of a display substrate according to some embodiments of the present disclosure;

FIG. 3 is a partial cross-sectional view of a display substrate according to some embodiments of the present disclosure;

FIG. 4 is a partial cross-sectional view of a display substrate according to some embodiments of the present disclosure;

FIG. 5 is a top view of a transparent conductive layer of the display substrate shown in FIG. 4;

FIG. 6 is a partial cross-sectional view of a display substrate according to some embodiments of the present disclosure;

FIG. 7 is a top view of a transparent conductive layer of the display substrate shown in FIG. 6;

FIG. 8 is a partial cross-sectional view of a display substrate according to some embodiments of the present disclosure;

FIG. 9 is a partial cross-sectional view of a display substrate according to some embodiments of the present disclosure; and FIG. 10 is a partial cross-sectional view of a display substrate according to some embodiments of the present disclosure.

### DETAILED DESCRIPTION

Reference is made in detail to exemplary embodiments, examples of which are illustrated in the accompanying drawings. The following description refers to the accompanying drawings in which the same numbers in different drawings represent the same or similar elements unless otherwise represented. The embodiments set forth in the following description of exemplary embodiments do not represent all embodiments consistent with the present disclosure. Instead, they are merely examples of apparatuses and methods consistent with aspects related to the present disclosure as recited in the appended claims.

The terms used in the present disclosure are only for the purpose of describing specific embodiments, but are not intended to limit the present disclosure. The singular forms “a”, “the” and “said” used in the present disclosure and the appended claims are intended to include the plural forms as well, unless otherwise clearly specified in the context. It should also be understood that the term “and/or” as used herein refers to and includes any one of or a combination of one or more associated items as listed.

It should be understood that although the terms first, second, third and the like may be used in the present disclosure to describe various information, these information should not be limited by these terms. These terms are merely used to distinguish information of the same type from one another. For example, first information may also be referred to as second information, and similarly, second information may also be referred to as first information, without departing from the scope of the present disclosure. Depending on the context, the word “if” as used herein can be interpreted as “when” or “while” or “in response to determining that”.

Impurity ions may be introduced during the manufacturing process of the display substrate. For example, impurity ions may be introduced during the manufacturing process of the color filter layer of the display substrate. During the display process of the display substrate, an electric field in the horizontal direction exists between adjacent pixel electrodes, and the impurity ions aggregate under the action of the electric fields in the horizontal direction, thereby affecting the quality of the display substrate. This effect is specifically manifested in the appearance of linear stains on the display substrate when it undergoes a black-and-white checkerboard test under high-temperature conditions, or in the phenomenon of motion blur when the display substrate switches from one frame to another.

Among these, the checkerboard test for the display substrate refers to the following process: the display region of the display substrate is divided into multiple display sub-regions, and the multiple display sub-regions are arranged in multiple rows and columns; for two adjacent display sub-regions in the same row, the sub-pixel grayscale of one display sub-region is 0 (making this display sub-region show black), while the sub-pixel grayscale of the other display sub-region is 255 (making that display sub-region show white); similarly, for two adjacent display sub-regions in the same column, the sub-pixel grayscale of one display sub-region is 0 (making this display sub-region show black), and the sub-pixel grayscale of the other display sub-region is 255 (making that display sub-region show white). After the display substrate undergoes the checkerboard test at high temperature for a period of time, linear stains extending along the row direction or column direction will appear, and these linear stains are located at the junctions of two adjacent display sub-regions.

Some embodiments of the present disclosure provide a display substrate and a display apparatus to solve the above problems. The display substrate and the display apparatus in the embodiments of the present disclosure are illustrated below in detail with reference to the accompanying drawings. The features in the embodiments described below may be complemented or combined with each other in the absence of conflicts.

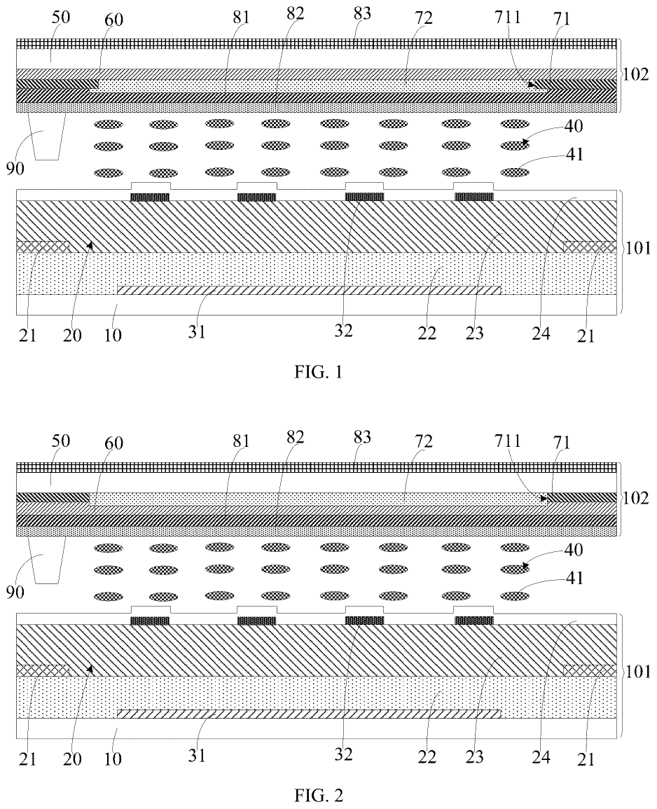

Some embodiments of the present disclosure provide a display substrate. The display substrate includes a display region. As shown in FIG. 1, the display substrate includes a first substrate 101, a second substrate 102, and a liquid crystal layer 40; and the first substrate 101 and the second substrate 102 are arranged opposite to each other, with the liquid crystal layer 40 disposed between the first substrate 101 and the second substrate 102.

The first substrate 101 includes a first base 10, and a drive circuit layer 20 disposed on a side of the first base 10 facing the second substrate 102. The second substrate 102 includes a second base 50, and a transparent conductive layer 60 disposed on a side of the second base 50 facing the first substrate 101, and the transparent conductive layer 60 is at least disposed in the display region.

According to the display substrate provided in the embodiments of the present disclosure, the transparent conductive layer 60 disposed at least in the display region is arranged on the side of the second base 50 of the second substrate 102 facing the first substrate 101, and the longitudinal electric field is formed between the transparent conductive layer 60 and the conductive structures in the first substrate 101, which prevents impurity ions from moving in the horizontal direction, thereby avoiding the aggregation of the impurity ions. In this way, the appearance of linear stains on the display substrate during the black-and-white checkerboard test and motion blur occurring when the display substrate switches from one frame to another can be improved, and the display quality of the display substrate is enhanced.

In some embodiments, as shown in FIG. 1, the liquid crystal layer 40 includes multiple liquid crystal molecules 41 arranged spaced apart.

In some embodiments, the liquid crystal molecules 41 are negative liquid crystal molecules. The material of the negative liquid crystal molecules has a high content of polar monomers, such that the display substrate is prone to linear stains during the black-and-white checkerboard test under high-temperature conditions.

In some embodiments, the liquid crystal molecules 41 of the liquid crystal layer 40 are negative liquid crystal molecules. This improves the contrast ratio and light transmittance of the display substrate.

In some embodiments, the display substrate further includes a frame sealant disposed between the first substrate 101 and the second substrate 102, and the frame sealant surrounds the liquid crystal layer 40. The first substrate 101 and the second substrate 102 are adhered together by means of a frame sealant.

In some embodiments, the first base 10 is a flexible substrate or a rigid substrate. The light transmittance of the first base 10 is high to reduce the light loss when the light emitted by a backlight source passes through the first base 10. The material of the flexible substrate includes one or more of polyimide, polyethylene terephthalate, polycarbonate, and organic resin materials. The organic resin materials includes epoxy resin, triazine, silicone resin or polyimide, among others. The rigid substrate includes, for example, any one of a glass substrate, a quartz substrate, a sapphire substrate, and the like.

In some embodiments, the display substrate further includes pixel electrodes and common electrodes. The display substrate is an advanced super dimension switch (ADS) display substrate. The ADS display substrate has a fast reaction speed, bright colors of displayed pictures, and high saturation. In the ADS display substrate, pixel electrodes and common electrodes are disposed on the same side of the liquid crystal layer. As shown in FIG. 1, both the common electrodes 31 and the pixel electrodes 32 are disposed on the first substrate 101 and on the side of the first base 10 facing the second substrate 102, and the pixel electrodes 32 and the common electrodes 31 are arranged opposite to each other.

In some embodiments, as shown in FIG. 1, the pixel electrodes 32 are strip-shaped electrodes, the first substrate 101 includes multiple pixel electrodes 32 arranged at intervals, the common electrodes 32 are plate-shaped electrodes, and each pixel electrode 32, the portion of the common electrodes 31 corresponding to the pixel electrode 32, and the liquid crystal molecules corresponding to the pixel electrode 32 form a sub-pixel.

In some other embodiments, the pixel electrodes and the common electrodes are strip-shaped electrodes and extend in the same direction. The pixel electrodes and the common electrode are in one-to-one correspondence, and each pixel electrode, the common electrode corresponding to the pixel electrode, and the liquid crystal molecules disposed between the pixel electrode and the common electrode form a sub-pixel.

In some embodiments, as shown in FIG. 1, the common electrodes 31 are disposed between the drive circuit layer 20 and the first base 10, and the pixel electrodes 32 are disposed on the side of the drive circuit layer 20 away from the first base 10. In other embodiments, the pixel electrodes 32 are disposed between the drive circuit layer 20 and the first base 10, and the common electrodes 31 are disposed on the side of the drive circuit layer 20 away from the first base 10. In some embodiments, the pixel electrodes 31 and the common electrodes 32 are made of transparent conductive materials. For example, the materials of the pixel electrodes 31 and the common electrodes 32 includes at least one of indium zinc oxide and indium tin oxide.

In some embodiments, the drive circuit layer 20 includes multiple pixel circuits in one-to-one correspondence to the sub-pixels, with each pixel circuit driving a corresponding sub-pixel. Each of the pixel circuits includes multiple thin-film transistors. Each of the pixel circuits further includes a capacitor.

In some embodiments, as shown in FIG. 1, the drive circuit layer 20 further includes multiple signal lines 21, a first insulation layer 22, and a second insulation layer 23 disposed on a side of the first insulation layer 22 away from the first base 10, and at least some of the signal lines 21 are disposed between the first insulation layer 22 and the second insulation layer 23. The multiple signal lines 21 include data signal lines, scan signal lines, power signal lines, etc. The signal lines 21 disposed between the first insulation layer 22 and the second insulation layer 23 include data lines. Conductive structures in the first substrate 101 includes gate, source and drain electrodes of the thin-film transistor, two polar plates of the capacitor, the signal line, the pixel electrode 32, and the common electrode 31. These conductive structures may form longitudinal electric fields with the transparent conductive layer 60 of the second substrate 102.

In some embodiments, as shown in FIG. 1, the display substrate further includes a liquid crystal alignment layer 24 disposed on a side of the drive circuit layer 20 away from the first base 10. The pixel electrodes 32 are disposed between the liquid crystal alignment film 24 and the drive circuit layer 20, and the liquid crystal alignment film 24 covers each pixel electrode 32. In some embodiments, the liquid crystal alignment film 24 is made of polyimide (PI). In other embodiments, the liquid crystal alignment film 24 is made of other organic materials.

In some embodiments, the second base 50 is a flexible substrate or a rigid substrate. The second base 50 has a high light transmittance to reduce light losses. A material of the flexible substrate includes, for example, one or more of polyimide, polyethylene terephthalate, polycarbonate, and organic resin materials. The organic resin materials include epoxy resin, triazine, silicone resin or polyimide, among others. The rigid substrate includes, for example, any one of a glass substrate, a quartz substrate, a sapphire substrate, and the like.

In some embodiments, as shown in FIG. 1, the second substrate 102 further includes a light-shielding layer 71 and a color filter layer 72 that are disposed on the side of the second base 50 facing the first substrate 101; the light-shielding layer 71 is provided with multiple openings 711, each of which corresponds to one sub-pixel; and the color filter layer 72 is at least partially disposed within the openings 711. In the embodiment shown in FIG. 1, the color filter layer 72 is partially disposed in the openings 711, and partially disposed on the side of the light-shielding layer 71 away from the second base 50. The color filter layer 72 includes color filter sub-layers of at least three different colors, and each color filter sub-layer includes multiple color filter portions arranged spaced apart, with one color filter portion disposed in one opening 711. In some embodiments, the color filter layer 72 includes a red color filter sub-layer, a green color filter sub-layer, and a blue color filter sub-layer. In some embodiments, a material of the light-shielding layer 71 is an organic resin doped with black particles. In some embodiments, as shown in FIG. 1, the second substrate 102 further includes a planarization layer 81 disposed on sides of the light-shielding layer 71 and the color filter layer 72 away from the second base 50. The surface of the planarization layer 81 away from the second base 50 remains substantially flush everywhere. A material of the planarization layer 81 is an organic resin.

In some embodiments, as shown in FIG. 1, the second substrate 102 further includes a liquid crystal alignment film 82 disposed on a side of the planarization layer 81 away from the second base 50. In some embodiments, the material of the liquid crystal alignment film 82 is PI. In other embodiments, the material of the liquid crystal alignment film 82 is other organic materials.

In some embodiments, as shown in FIG. 1, the second substrate 102 further includes a spacer 90 disposed on a side of the liquid crystal alignment film 82 facing the first substrate 101. A material of the spacer 90 is an organic resin.

In some embodiments, as shown in FIG. 1, the second substrate 102 further includes an electrostatic discharge layer 83 disposed on the side of the second base 50 away from the first substrate 101. The electrostatic discharge layer 83 discharges electrostatic charges on the surface of the display substrate, to prevent the conduction of electrostatic charges accumulated on the surface of the display substrate towards a direction close to the first base 10, and to effectively avoid the problem of the characteristic deviation of the thin-film transistors of the pixel circuits due to the conduction of the electrostatic charges to the drive circuit layer 20, such that the display effect of a display panel is improved.

In some embodiments, an orthographic projection of the electrostatic discharge layer 83 on the second base 50 covers the second base 50. In this way, the electrostatic discharge layer 83 more effectively prevents the conduction of the electrostatic charges towards the drive circuit layer 20 of the first substrate 101. The electrostatic discharge layer 83 is connected to a constant electrical signal. For example, the electrostatic discharge layer 83 is connected to a ground signal.

In some embodiments, the electrostatic discharge layer 83 is made of a transparent conductive material. A material of the electrostatic discharge layer 83 includes, for example, at least one of metal oxides, graphene, metal nanowires, carbon nanotubes, conductive polymers, and poly(3,4-ethylenedioxythiophene)-polystyrene sulfonic acid. Among the metal oxides, graphene, metal nanowires, carbon nanotubes, conductive polymers, and poly(3,4-ethylenedioxythiophene)-polystyrene sulfonic acid, not all of these materials can be used for the material of the electrostatic discharge layer 83, and only materials with higher light transmittance among these materials can be used for the material of the electrostatic discharge layer 83 to reduce the influence on the light transmittance of the display substrate. For example, the electrostatic discharge layer 83 is made of materials with high light transmittance such as indium tin oxide and indium zinc oxide among the metal oxides.

In some embodiments, as shown in FIG. 1 to FIG. 3, an orthographic projection of the transparent conductive layer 60 on the second base 50 covers the second base 50. In this configuration, the transparent conductive layer 60 achieves a large area, and the electric fields formed between the transparent conductive layer 60 and the conductive structures in the first substrate 101 achieve great intensity, such that the aggregation of impurity ions is prevented more effectively to further enhance the display quality of the display substrate. The display substrate further includes a peripheral region disposed outside the display region, and the transparent conductive layer 60 covers the display region and the peripheral region. In this way, the transparent conductive layer 60 provides electrostatic protection for the peripheral region to enhance the anti-static capability of the display substrate.

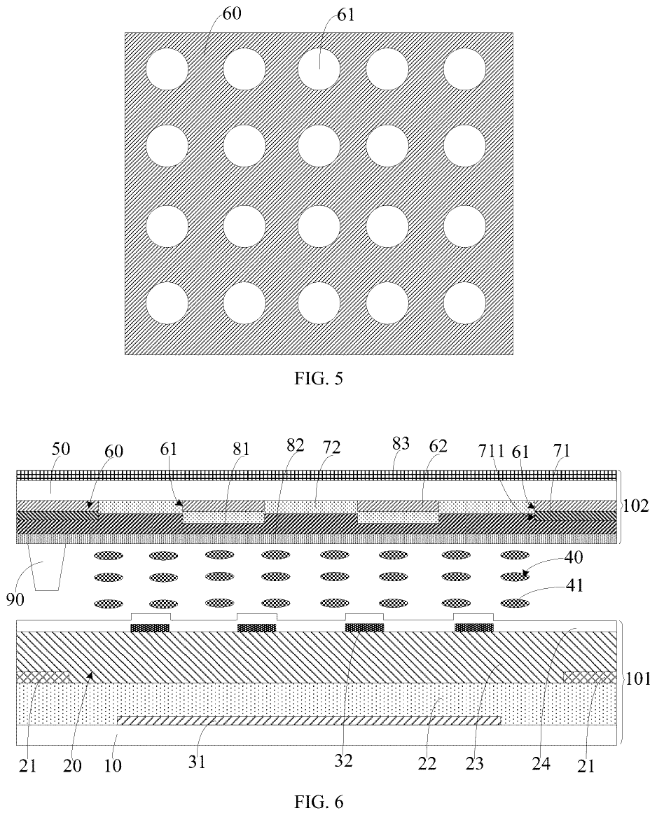

In some other embodiments, as shown in FIG. 4 to FIG. 7, the transparent conductive layer 60 is provided with multiple hollowed-out portions 61.

In some embodiments, the second substrate 102 includes patterned functional layers disposed on the side of the second base 50 facing the first substrate 101, and an orthographic projection of the transparent conductive layer 60 on the second base 50 overlaps an orthographic projection of one of the patterned functional layers on the second base 50. In this configuration, the transparent conductive layer 60 and the functional layer may be produced using the same mask, contributing to reducing the production cost of the display substrate.

In some embodiments, the patterned functional layers of the second substrate 102 includes a light-shielding layer 71 and the color filter sub-layers. That is, the transparent conductive layer 60 is produced using the same mask as the light-shielding layer 71, or as one color filter sub-layer.

In some embodiments, as shown in FIG. 4 and FIG. 5, an orthographic projection of the transparent conductive layer 60 on the second base 50 overlaps an orthographic projection of the light-shielding layer 71 on the second base 50. This can reduce the production cost of the display substrate while maximizing the light transmittance of the display substrate. After experimental verification, the light transmittance of the display substrates shown in FIG. 4 and FIG. 5 is increased by approximately 5% compared to the light transmittance of the display substrates shown in FIG. 1 to FIG. 3. In the embodiments shown in FIG. 4 and FIG. 5, the hollowed-out portions 61 are through holes.

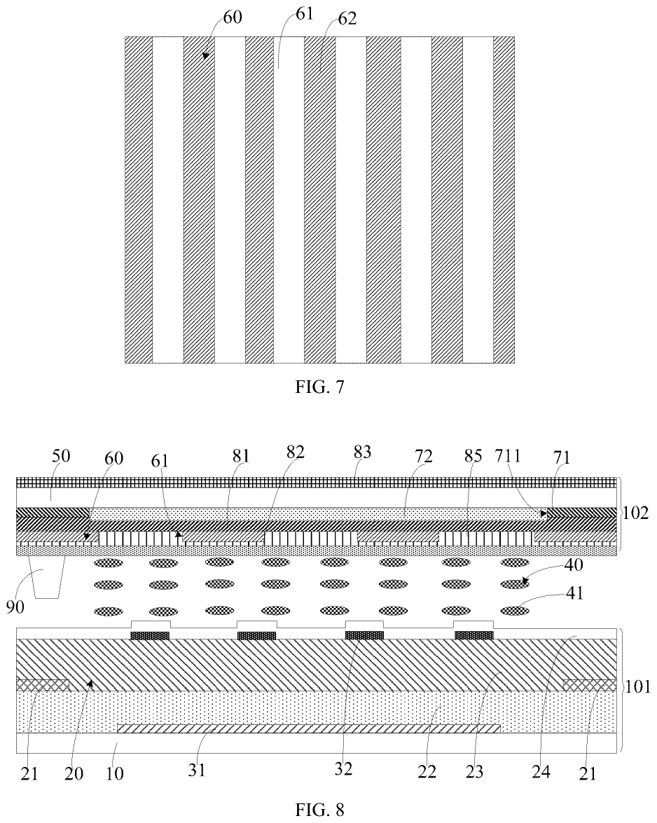

In some embodiments, as shown in FIG. 6 and FIG. 7, the transparent conductive layer 60 includes multiple strip-shaped conductive structures 62 extending in the same direction, with adjacent strip-shaped conductive structures 62 spaced apart. The gap between adjacent strip-shaped conductive structures 62 is the hollowed-out portion 61. That is, the hollowed-out portion 61 is elongated, the length direction of the strip-shaped conductive structure 62 is the same as that of the hollowed-out portion 61, and the length of the hollowed-out portion 61 is the same as the length of the light-shielding layer 71. The length direction of the hollowed-out portion 61 may be a row or column direction in which the sub-pixels in the display substrate are arranged. In other embodiments, the angle between the length direction of the hollowed-out portion 61 and the row or column direction in which the sub-pixels are arranged may be an acute angle. In the embodiments shown in FIG. 6 and FIG. 7, the size of the hollowed-out portion 61 is smaller than the size of the opening 711 of the light-shielding layer 71 in the width direction of the hollowed-out portion 61. In other embodiments, the size of the hollowed-out portion 61 is greater than or equal to the size of the opening 711 of the light-shielding layer 71 in the width direction of the hollowed-out portion 61. In the embodiment shown in FIG. 6, the size of the opening 711 of the light-shielding layer 71 is equal to a sum of the size of three hollowed-out portions 61 and the size of two strip-shaped conductive structures 62 in the width direction of the hollowed-out portion 61. After experimental verification, the light transmittance of the display substrate shown in FIG. 6 is increased by approximately 4% compared with the light transmittance of the display substrate shown in FIG. 1 to FIG. 3.

In some embodiments, as shown in FIG. 4 and FIG. 5, an orthographic projection of each of the hollowed-out portions 61 on the second base 50 at least partially overlaps an orthographic projection of one of the openings 711 of the light-shielding layer 71 on the second base 50. Since the region where the opening 711 of the light-shielding layer 71 is disposed is a light transmitting region of the display substrate, the orthographic projection of the hollowed-out portion 61 on the second base 50 at least partially overlaps with the orthographic projection of one opening 711 of the light-shielding layer 71 on the second base 50, such that the arrangement of the hollowed-out portion 61 of the transparent conductive layer 60 increases the light transmittance of the display substrate, contributing to increasing the light utilization rate of the display substrate.

In some embodiments, a thickness of the transparent conductive layer 60 is less than or equal to a thickness of the electrostatic discharge layer 83. In the case that the thickness of the transparent conductive layer 60 is smaller than that of the electrostatic discharge layer 83, the light transmittance of the transparent conductive layer 60 is made larger, contributing to increasing the light transmittance of the display substrate.

In some embodiments, the thickness of the transparent conductive layer 60 is in a range of 120 Å to 1,200 Å. In some embodiments, the thickness of the transparent conductive layer 60 is 120 Å, 200 Å, 400 Å, 600 Å, 800 Å, 1000 Å, 1200 Å, etc.

In some embodiments, a minimum thickness of the transparent conductive layer 60 is 10% of the thickness of the electrostatic discharge layer 83. For example, the thickness of the electrostatic discharge layer 83 is 1200 Å, and the minimum thickness of the transparent conductive layer 60 is 120 Å.

In another embodiment, a thickness of the transparent conductive layer 60 is equal to the thickness of the electrostatic discharge layer 83. In this configuration, the process parameters used to produce the transparent conductive layer 60 are the same as those used to produce the electrostatic discharge layer 83, contributing to simplifying the process for producing the display substrate.

In some embodiments, a material of the transparent conductive layer 60 includes at least one of metal oxides, graphene, metal nanowires, carbon nanotubes, conductive polymers, and poly(3,4-ethylenedioxythiophene)-polystyrene sulfonic acid. Among the metal oxides, graphene, metal nanowires, carbon nanotubes, conductive polymers, and poly(3,4-ethylenedioxythiophene)-polystyrene sulfonic acid, not all of these materials can be used for the material of the transparent conductive layer 60, and only materials with higher light transmittance among these materials can be used for the material of the transparent conductive layer 60 to reduce the influence on the light transmittance of the display substrate. For example, the transparent conductive layer 60 is made of materials with high light transmittance such as indium tin oxide and indium zinc oxide among the metal oxides.

In some embodiments, an orthographic projection of a gap between adjacent pixel electrodes 32 in the first substrate 101 on the second base 50 falls within an orthographic projection of the transparent conductive layer 60 on the second base 50. The aggregation of impurity ions in the display substrate is mainly caused by the electric fields formed in the horizontal direction between adjacent pixel electrodes 32. The impurity ions are more likely to aggregate in regions where the gap between adjacent pixel electrodes 32 is disposed. The orthogonal projection of the gap between adjacent pixel electrodes 32 in the first substrate 101, on the second base 50, is set to fall within the orthogonal projection of the transparent conductive layer 60 on the second base 50, such that the transparent conductive layer 60 and the conductive structures of the first substrate 101 may form electric fields in regions where the gap between adjacent pixel electrodes 32 is disposed. In this way, the impurity ions are effectively prevented from aggregating in the regions where the gap between adjacent pixel electrodes 32 is disposed, such that the display effect of the display substrate are improved more effectively.

In some embodiments, as shown in FIG. 1, FIG. 4 and FIG. 6, the transparent conductive layer 60 is disposed between the second base 50 and the light-shielding layer 71. That is, the transparent conductive layer 60 is formed on the second base 50. Due to good surface flatness of the second base 50, the formation of the transparent conductive layer 60 on the second base 50 contributes to small thickness of the transparent conductive layer 60.

In some embodiments, as shown in FIG. 4 and FIG. 6, the transparent conductive layer 60 is disposed between the second base 50 and the light-shielding layer 71, the transparent conductive layer 60 is provided with a hollowed-out portion 61, and the color filter layer 72 is partially disposed within the hollowed-out portion 61 of the transparent conductive layer 60.

In some other embodiments, as shown in FIG. 2, the transparent conductive layer 60 is disposed between the color filter layer 72 and the planarization layer 81. Compared with the solution in which the transparent conductive layer 60 is disposed between the light-shielding layer 71 and the second base 50, the configuration of the transparent conductive layer 60 between the color filter layer 72 and the planarization layer 81 reduces the distance between the transparent conductive layer 60 and the first substrate 101, which increases, under the premise of constant area of the transparent conductive layer 60, the intensity of the electric fields between the transparent conductive layer 60 and the conductive structures of the first substrate 101, thereby facilitating to preventing the aggregation of impurity ions.

In some other embodiments, the transparent conductive layer 60 is disposed between the light-shielding layer 71 and the color filter layer 72, and the transparent conductive layer 60 is partially disposed within the openings 711 of the light-shielding layer 71.

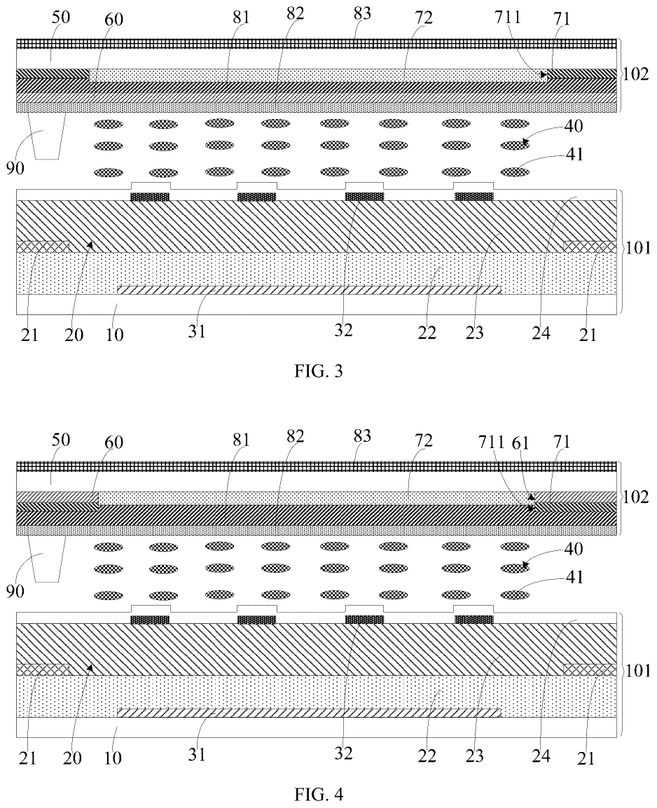

In some other embodiments, as shown in FIG. 3, the transparent conductive layer 60 is disposed on a side of the planarization layer 81 away from the second base 50. Also, the transparent conductive layer 60 is disposed between the planarization layer 81 and the second liquid crystal alignment film 82. In this configuration, the distance between the transparent conductive layer 60 and the first substrate 101 is further reduced, and under the premise of constant area of the transparent conductive layer 60, the intensity of the electric fields between the transparent conductive layer 60 and the conductive structures of the first substrate 101 is further increased, such that the aggregation of impurity ions is prevented more effectively.

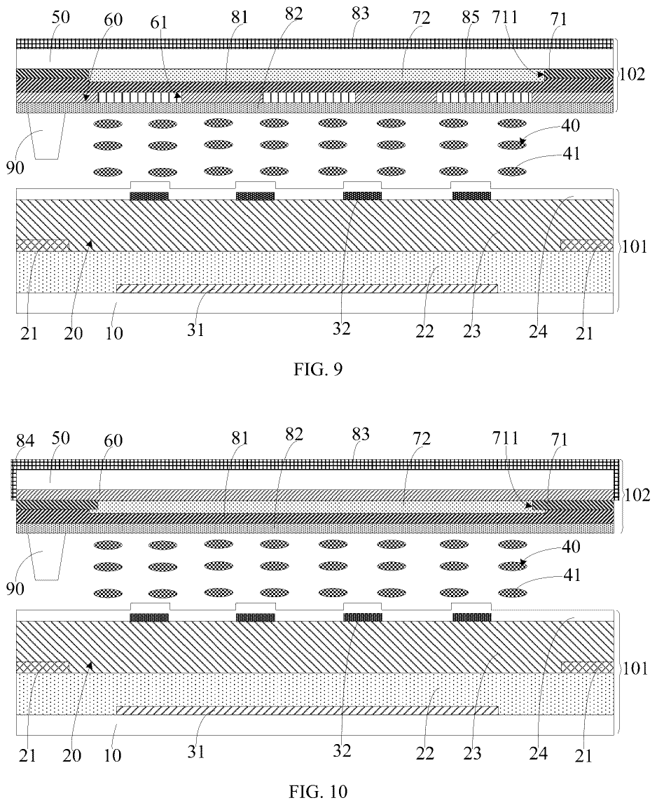

In some embodiments, as shown in FIG. 8 and FIG. 9, the transparent conductive layer 60 is disposed between the planarization layer 81 and the second liquid crystal alignment film 82, the transparent conductive layer 60 is provided with a hollowed-out portion 61, and the display substrate further includes a planarization layer 85 disposed at least partially within the hollowed-out portion 61. The arrangement of the planarization layer 85 prevents the liquid crystal alignment film 82 from being uneven in the layer.

In some embodiments shown in FIG. 8, the planarization layer 85 is partially disposed in the hollowed-out portion 61, and partially disposed on the side of the transparent conductive layer 60 away from the second base 50, and the surface of the planarization layer 85 away from the second base 50 remains substantially flush everywhere. In some embodiments shown in FIG. 9, the entire planarization layer 85 is disposed in the hollowed-out portion 61, and the surface of the planarization layer 85 away from the second base 50 is flush with the surface of the transparent conductive layer 60 away from the second base 50.

In some other embodiments, in the case that the transparent conductive layer 60 is disposed between the planarization layer 81 and the second liquid crystal alignment film 82, the thickness of the transparent conductive layer 60 is set to be very small, for example, 120 Å. This contributes to improving the layer flatness of the liquid crystal alignment film 82.

In some embodiments, the transparent conductive layer 60 is connected to a constant electrical signal. In this configuration, the intensity of the electric fields between the transparent conductive layer 60 and the conductive structures of the first substrate 101 is effectively increased, such that the aggregation of impurity ions is prevented more effectively.

Further, the electrostatic discharge layer 83 is connected to a constant electrical signal; and the transparent conductive layer 60 is electrically connected to the electrostatic discharge layer 83. In this configuration, the transparent conductive layer 60 is electrically connected to the electrostatic discharge layer 83 to achieve connection to a constant electric signal, such that there is no need to arrange a signal line for the transparent conductive layer 60 to provide a constant electrical signal, contributing to simplifying the structure of the display substrate.

Further, as shown in FIG. 10, the second substrate 102 further includes a conductive portion 84 disposed on a side portion of the second base 50, and the electrostatic discharge layer 83 and the transparent conductive layer 60 are electrically connected to the conductive portion 84, respectively. The provision of the conductive portion 84 on the side portion of the second base 50 to achieve the electrical connection between the transparent conductive layer 60 and the electrostatic discharge layer 83 contributes to reducing the difficulty in producing the display substrate, as compared with the solution of providing through holes in the second base 50 to achieve the electrical connection between the transparent conductive layer 60 and the electrostatic discharge layer 83.

In some embodiments, the conductive portion 84 covers all sides of the second base 50. In other embodiments, the conductive portion 84 covers only some sides of the second base 50.

In some embodiments, the material of the conductive portion 84 is the same as the material of the electrostatic discharge layer 83 or the material of the transparent conductive layer 60, or the material of the conductive portion 84 is different from the material of the electrostatic discharge layer 83 and the material of the transparent conductive layer 60. In some embodiments, the conductive portion 84 is obtained by coating silver paste on the sides of the second base 50.

The following will describe each layer included in the display substrate according to the embodiment shown in FIG. 1. As shown in FIG. 1, the display substrate includes a first substrate 101 and a second substrate 102 that are arranged opposite to each other, and a liquid crystal layer 40 disposed between the first substrate 101 and the second substrate 102. The liquid crystal layer 40 includes multiple liquid crystal molecules, which are negative liquid crystal molecules.

The first substrate 101 includes a first base 10, a drive circuit layer 20, common electrodes 31, and pixel electrodes 32 that are all disposed on the side of the first base 10 facing the second substrate 102. The drive circuit layer 20 includes multiple pixel circuits. The common electrodes 31 are disposed between the drive circuit layer 20 and the first base 10, and the pixel electrodes 32 are disposed on the side of the drive circuit layer 20 away from the first base 10.

The second substrate 102 includes a second base 50, a transparent conductive layer 60, a light-shielding layer 71, a color filter layer 72, a planarization layer 81, a liquid crystal alignment film 82, and an electrostatic discharge layer 83. The transparent conductive layer 60 is disposed on the side of the second base 50 facing the first base 101, and an orthographic projection of the transparent conductive layer 60 on the second base 50 covers the second base 50. The light-shielding layer 71 is disposed on the side of the transparent conductive layer 60 facing the first substrate 101, and is provided with multiple openings 711 arranged spaced apart. The color filter layer 72 is partially disposed in the openings 711, and partially disposed on the side of the light-shielding layer 71 away from the second base 50. The planarization layer 81 is disposed on the side of the color filter layer 72 facing the first substrate 101, and a partial region of the planarization layer 81 may contact a surface of the light-shielding layer 71 that is not covered by the color filter layer 72. The liquid crystal alignment film 82 is disposed on the side of the planarization layer 81 facing the first substrate 101. The electrostatic discharge layer 83 is disposed on the side of the second base 50 away from the first substrate 101. An orthographic projection of the electrostatic discharge layer 83 on the second base 50 may cover the second base 50.

Further, the second base 50, the light-shielding layer 71, the color filter layer 72, and the planarization layer 81 each have a thickness greater than the thickness of the transparent conductive layer 60. In some embodiments, the second base 50, the light-shielding layer 71, the color filter layer 72, and the planarization layer 81 each have a thickness greater than the thickness of the transparent conductive layer 60.

Further, the thickness of the light-shielding layer 71 may gradually decrease from a region away from the openings 711 to a region close to the openings 711. The surface of the light-shielding layer 71 facing the second base 50 may be substantially flush, and the surface of the light-shielding layer 71 away from the second base 50 may be a relatively smooth surface.

Further, a recess is formed on the surface of the color filter layer 72 that is disposed on the side of the light-shielding layer 71 away from the second base 50 and partially faces the first substrate 101, and the planarization layer 81 fills this recess.

To verify the improved display effect achieved by the display substrate according to the embodiments of the present disclosure, a checkerboard test was conducted on the display substrate shown in FIG. 1 and a comparative display substrate. The comparative display substrate differs from the one shown in FIG. 1 in that the second substrate does not include a transparent conductive layer. According to the test results, the display substrate shown in FIG. 1 showed no linear stains after continuous display of a checkerboard pattern for 1000 hours, while the comparative display substrate showed linear stains after continuous display of the checkerboard pattern for 360 hours. It can be seen that the embodiments of the present disclosure effectively extends the linear stain-free service time of the display substrate, and solves the problem of screen stains caused by impurity ions within the display substrate.

To verify the effect of the provided transparent conductive layer on the brightness of the display substrate, a simulation experiment was conducted on two types of display substrates (hereinafter referred to as a first display substrate and a second display substrate) in the present disclosure. In the simulation experiment, the first and second display substrates were simulated to display a black and white checkerboard image. In to the case that the second substrate of the first display substrate includes only the second base, a simulation test was conducted to acquire the brightness of the first display substrate at the junction between the black display sub-region and the white display sub-region; and then, in the case that a light-shielding layer is additionally provided on the side of the second base facing the first substrate, a simulation test was conducted to acquire the brightness of the first display substrate at the junction between the black display sub-region and the white display sub-region. A comparison revealed that the additional provision of the light-shielding layer to the second substrate of the first display substrate reduced the brightness of the first display substrate at the junction between the black display sub-region and the white display sub-region by 0.01%. In to the case that the second substrate of the second display substrate includes only the second base, a simulation test was conducted to acquire the brightness of the second display substrate at the junction between the black display sub-region and the white display sub-region; and then, after a transparent conductive layer disposed on the side of the second base facing the first substrate and a light-shielding layer disposed on the side of the transparent conductive layer away from the second base are additionally provided, with the transparent conductive layer covering the second base, a simulation test was conducted again to acquire the brightness of the second display substrate at the junction between the black display sub-region and the white display sub-region. A comparison revealed that the additional provision of the light-shielding layer and the transparent conductive layer to the second substrate of the second display substrate reduced the brightness of the second display substrate at the junction between the black display sub-region and the white display sub-region by 0.004%. Based on a comparison of brightness changes between the first display substrate and the second display substrate, the provision of the transparent conductive layer to the second display substrate increased the brightness of the second display substrate at the junction between the black display sub-region and the white display sub-region by 60%, as compared to the first display substrate. This is because the transparent conductive layer in the second display substrate prevents the aggregation of impurity ions, thereby improving the reduced brightness of the display substrate at the junction between the black display sub-region and the white display sub-region due to the aggregation of impurities ions.

In the embodiments of the present disclosure, simulation tests were also conducted for the brightness distribution of the first display substrate provided with the light-shielding layer and for the brightness distribution of the second display substrate provided with the light-shielding layer and the transparent conductive layer. Based on simulation results, the second display substrate shows more uniform brightness distribution and better display effect. As can be seen, the transparent conductive layer achieves the effect of improving the uniformity in the brightness distribution of the display substrate by preventing the aggregation of impurity ions.

Some embodiments of the present disclosure further provide a method for producing a display substrate. A process for producing the display substrate are as follows.

First, a first substrate and a second substrate are prepared.

Then, a frame sealant is applied on one of the side of the first substrate away from the first base and the side of the second substrate away from the electrostatic discharge layer, a liquid crystal layer is applied on the other one of the side of the first substrate away from the first base and the side of the second substrate away from the electrostatic discharge layer, and the first substrate and the second substrate are assembled.

Then, the frame sealant is cured.

The following describes a method for producing a first substrate by taking the second substrate of the display substrate shown in FIG. 1 as an example. A process for producing the second substrate may include the following steps:
providing a second base;
forming an electrostatic discharge layer on a side of the second base;
forming a transparent conductive layer on a side of the second base away from the electrostatic discharge layer;
forming a light-shielding layer on a side of the transparent conductive layer away from the second base, the light-shielding layer being provided with openings;
forming a color filter layer on a side of the transparent conductive layer away from the second base, with the color filter layer at least partially disposed within the openings in the light-shielding layer;
forming a planarization layer on a side of the color filter layer away from the second base;
forming a second liquid crystal alignment layer on a side of the planarization layer away from the second base; and forming a spacer on a side of the second liquid crystal alignment layer away from the second base.

The embodiments of the method for producing a display substrate according to some embodiments of the present disclosure and the embodiments of the display substrate pertain to the same inventive conception, and the descriptions of their relevant details and beneficial effects can be referred to each other, which are not repeated here.

Some embodiments of the present disclosure further provides a display apparatus. The display apparatus includes the display substrate described in any one of the embodiments described above.

In some embodiments, the display substrate further includes a backlight source disposed on a side of the first substrate away from the second substrate.

In some embodiments, the display apparatus further includes a housing, and the display substrate is embedded in the housing.

The display apparatus provided in the embodiments of the present disclosure may be any appropriate display apparatus, including but not limited to: a mobile phone, a tablet computer, a television, a displayer, a notebook computer, a digital photo frame, a navigator, an electronic book, or any products or components that have a display function.

It should be noted that in the accompanying drawings, the sizes of the layers and regions may be exaggerated for clarity of illustration. Also, it should be understood that in the case that an element or layer is referred to as being “on” another element or layer, it may be directly on the other element, or an intermediate layer may be present. In addition, it should be understood that in the case that an element or layer is referred to as being “under” another element or layer, it may be directly under the other element, or one or more intermediate layers or elements may be present. In addition, it should also be understood that in the case that a layer or element is referred to as being “between” two layers or elements, it may be the only layer between the two layers or elements, or one or more intermediate layers or elements may also be present. Like reference numerals refer to like elements throughout the present disclosure.

Other embodiments of the present disclosure are readily conceivable to those skilled in the art from consideration of the specification and the practice of the present disclosure herein. The present disclosure is intended to cover any variations, uses, or adaptations of the present disclosure following the general principles of the present disclosure and including the common knowledge or conventional technical means in the art, which are not disclosed in the present disclosure. The specification and embodiments are to be considered as exemplary only, and the true scope and spirit of the present disclosure are as indicated by the appended claims.

It will be appreciated that the present disclosure is not limited to the exact construction that has been described above and shown in the accompanying drawings, and that various modifications and changes can be made without departing from the scope thereof. It is intended that the scope of the present disclosure is only limited by the appended claims.
This listing of claims will replace all prior versions, and listings, of claims in the application:

1. A display substrate, provided with a display region and comprising a first substrate, a second substrate disposed opposite to the first substrate, and a liquid crystal layer disposed between the first substrate and the second substrate; wherein
the first substrate comprises a first base, and a drive circuit layer, pixel electrodes, and common electrodes that are disposed on a side of the first base facing the second substrate; and the second substrate comprises a second base and a transparent conductive layer disposed on a side of the second base facing the first substrate, the transparent conductive layer being at least disposed in the display region.

2. The display substrate according to claim 1, wherein an orthographic projection of the transparent conductive layer on the second base covers the second base.

3. The display substrate according to claim 1, wherein the transparent conductive layer is provided with a plurality of hollowed-out portions.

4. The display substrate according to claim 3, wherein the second substrate further comprises a light-shielding layer disposed on the side of the second base facing the first substrate, the light-shielding layer is provided with a plurality of openings, and an orthographic projection of each of the hollowed-out portions on the second base at least partially overlaps an orthographic projection of one of the openings on the second base.

5. The display substrate according to claim 3, wherein the second substrate further comprises patterned functional layers disposed on the side of the second base facing the first substrate, and an orthographic projection of the transparent conductive layer on the second base overlaps an orthographic projection of one of the functional layers on the second base.

6. The display substrate according to claim 5, wherein the second substrate further comprises a light-shielding layer and a color filter layer that are disposed on the side of the second base facing the first substrate, the light-shielding layer is provided with a plurality of openings, the color filter layer comprises color filter sub-layers of at least three different colors, and the patterned functional layers comprises the light-shielding layer and the color filter sub-layers.

7. The display substrate according to claim 3, wherein the transparent conductive layer comprises a plurality of strip-shaped conductive structures extending in a same direction, and adjacent strip-shaped conductive structures are arranged at intervals.

8. The display substrate according to claim 1, wherein the second substrate further comprises a light-shielding layer provided with openings and a color filter layer at least partially located in the openings, both of which are disposed on the side of the second base facing the first substrate; and
the transparent conductive layer is disposed between the second base and the light-shielding layer.

9. The display substrate according to claim 1, wherein the second substrate further comprises a light-shielding layer provided with openings, a color filter layer at least partially located in the openings, and a planarization layer located on a side of the color filter layer away from the second base, all of which are disposed on the side of the second base facing the first substrate; and
the transparent conductive layer is disposed between the color filter layer and the planarization layer.

10. The display substrate according to claim 1, wherein the second substrate further comprises a light-shielding layer provided with openings, a color filter layer at least partially located in the openings, and a planarization layer located on a side of the color filter layer away from the second base, all of which are disposed on the side of the second base facing the first substrate; and
the transparent conductive layer is disposed on a side of the planarization layer away from the second base.

11. The display substrate according to claim 1, wherein the second substrate further comprises an electrostatic discharge layer disposed on a side of the second base away from the first substrate; and
a thickness of the transparent conductive layer is less than or equal to a thickness of the electrostatic discharge layer.

12. The display substrate according to claim 11, wherein a minimum thickness of the transparent conductive layer is equal to 10% of the thickness of the electrostatic discharge layer.

13. The display substrate according to claim 1, wherein the transparent conductive layer is connected to a constant electrical signal.

14. The display substrate according to claim 13, wherein the second substrate further comprises an electrostatic discharge layer disposed on a side of the second base away from the first substrate, the electrostatic discharge layer being connected to a constant electrical signal; and
the transparent conductive layer is electrically connected to the electrostatic discharge layer.

15. The display substrate according to claim 14, wherein the second substrate further comprises a conductive portion disposed on a side portion of the second base, and both the electrostatic discharge layer and the transparent conductive layer are electrically connected to the conductive portion.

16. The display substrate according to claim 1, wherein the transparent conductive layer is in contact with the second base, and an orthographic projection of the transparent conductive layer on the second base covers the second base; the second substrate further comprises a light-shielding layer disposed on a side of the transparent conductive layer away from the second base, a color filter layer disposed at least partially on a side of the light-shielding layer away from the second base, a planarization layer disposed on a side of the color filter layer away from the second base, and a liquid crystal alignment film disposed on a side of the planarization layer away from the second base.

17. The display substrate according to claim 16, wherein the second base, the light-shielding layer, the color filter layer, and the planarization layer each have a thickness greater than a thickness of the transparent conductive layer.

18. The display substrate according to claim 1, wherein the first substrate comprises a plurality of pixel electrodes arranged spaced apart, and an orthographic projection of a gap between adjacent pixel electrodes on the second base falls within an orthographic projection of the transparent conductive layer on the second base.

19. The display substrate according to claim 1, wherein a material of the transparent conductive layer comprises at least one of metal oxides, graphene, metal nanowires, carbon nanotubes, conductive polymers, and poly(3,4-ethylenedioxythiophene)-polystyrene sulfonic acid.

20. A display apparatus, comprising a display substrate and a backlight source, wherein the display substrate is provided with a display region and comprises a first substrate, a second substrate disposed opposite to the first substrate, and a liquid crystal layer disposed between the first substrate and the second substrate; wherein
the first substrate comprises a first base, and a drive circuit layer, pixel electrodes, and common electrodes that are disposed on a side of the first base facing the second substrate; and the second substrate comprises a second base and a transparent conductive layer disposed on a side of the second base facing the first substrate, the transparent conductive layer being at least disposed in the display region, and
a backlight source disposed on a side of the first substrate away from the second substrate.
